(19) United States
(12) Patent Application Publication
(10) Pub. No.: US 2024/0328682 A1
(43) Pub. Date: Oct. 3, 2024

(54) Laminate for Color Radiative Cooling and Radiative Cooling Material Including the Same

(71) Applicants: Hyundai Motor Company, Seoul (KR); Kia Corporation, Seoul (KR)

(72) Inventor: Min Jae Lee, Seongnam-si (KR)

(21) Appl. No.: 18/459,738

(22) Filed: Sep. 1, 2023

(30) Foreign Application Priority Data
Mar. 28, 2023 (KR) 10-2023-0040606

(51) Int. Cl. F25B 23/00; B32B 15/09; B32B 27/08; B32B 27/36

(52) U.S. Cl. CPC F25B 23/003; B32B 15/09; B32B 27/08; B32B 27/36; B32B 2250/05; B32B 2307/402; B32B 2307/414; B32B 2307/416; B32B 2307/7376

(57) ABSTRACT

An embodiment laminate for color radiative cooling includes a colored layer including a thermoplastic resin, a far-infrared ray emissive layer on the colored layer, wherein a first layer including an aromatic polyester and a second layer including a non-aromatic poly (ether-ester) copolymer are alternately stacked in the far-infrared ray emissive layer, and a near-infrared ray reflective layer on the far-infrared ray emissive layer and including a metal.

### CROSS-REFERENCE TO RELATED APPLICATIONS

This application claims the benefit of Korean Patent Application No. 10-2023-0040606, filed on Mar. 28, 2023, which application is hereby incorporated herein by reference.

### TECHNICAL FIELD

The present disclosure relates to a laminate for color radiative cooling and a radiative cooling material including the same.

### BACKGROUND

In general, energy consumption is essential for cooling. For example, general-purpose cooling devices such as a refrigerator and an air conditioner compress a refrigerant using energy and then perform the cooling by absorbing heat generated when the compressed refrigerant expands. Radiative cooling is a technology capable of performing the cooling without consuming the energy, unlike the general-purpose cooling device. To improve a radiative cooling efficiency, it is important to well control absorbency, reflectivity, and emissivity of light in each wavelength band. Most of the heat may be generated from incident sunlight and the sunlight may be divided into an ultraviolet (UV) ray, a visible ray, and an infrared ray. When the light of each wavelength band is reflected, inflow of the heat via the sunlight may be blocked. For example, an interior temperature of a black vehicle that absorbs light well rises easily on a sunny day, but a rise of an interior temperature of a white vehicle that reflects light relatively well without absorbing light is relatively slow.

As a material for such radiative cooling, various materials such as a polymer, a multi-layer thin film of inorganic materials or ceramic materials, a radiative cooling material including a metal reflective layer, a paint containing a white pigment, and the like are used. The polymer material generally has a high infrared absorptivity (emissivity) but has a short lifespan because the polymer material is easily deteriorated by the ultraviolet ray, moisture, and the like when left outdoors because of a nature of the material. In a case of the multi-layer thin film, the number of layers must be increased to increase the infrared emissivity, which increases an absorptivity for the sunlight, so that there is a limit in achieving a high-efficiency radiative cooling performance. In addition, the material including the metal reflective layer is difficult to be applied in real life because of problems of low long-term stability caused by oxidation of the metal and a unit cost and causes eye fatigue and light scattering because of regular reflection of such a metal material. The paint containing the white pigment is not usually composed of a material having a high extinction coefficient, so that there is a problem of insufficient radiative cooling performance resulted from insufficient infrared emissivity and ultraviolet reflectance.

As an alternative to such problem, Korean Patent No. 2154072 (Patent Document 1) discloses a coolant capable of rendering a color in the radiative cooling, containing a first material that emits the infrared ray to cause the radiative cooling, and a second material that absorbs light in an area of the visible ray, converts a wavelength of the light, and emits the light. However, as in Patent Document 1, the coolant in which the second material such as a dye or a semiconductor material is mixed with the first material that emits the infrared ray by electromagnetic resonance has a problem of the insufficient radiative cooling performance resulted from the low ultraviolet reflectance.

Therefore, there is a need for research and development on a material having excellent ultraviolet, visible, and near-infrared reflectivity and excellent far-infrared emissivity and thus having excellent radiative cooling performance.

### SUMMARY

The present disclosure relates to a laminate for color radiative cooling and a radiative cooling material including the same. Particular embodiments relate to a laminate for color radiative cooling and a radiative cooling material including the same having excellent visible and infrared reflectivity and excellent cooling effect.

Embodiments of the present disclosure can solve problems occurring in the prior art while advantages achieved by the prior art are maintained intact.

An embodiment of the present disclosure provides a laminate and a radiative cooling material including the same having excellent ultraviolet, visible, and near-infrared reflectivity and excellent far-infrared emissivity and thus having excellent radiative cooling performance.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a laminate for color radiative cooling includes a colored layer containing a thermoplastic resin, a far-infrared ray emissive layer formed on the colored layer, wherein a first layer containing aromatic polyester and a second layer containing a non-aromatic poly (ether-ester) copolymer are alternately stacked in the far-infrared ray emissive layer, and a near-infrared ray reflective layer formed on the far-infrared ray emissive layer and containing a metal.

According to another embodiment of the present disclosure, a radiative cooling material includes the laminate for the color radiative cooling.

According to another embodiment of the present disclosure, a vehicle, an aircraft, a robot, or a building contains the radiative cooling material. In this regard, the aircraft may include an advanced air mobility (AAM), an urban air mobility (UAM), and the like.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a cross-sectional view of a laminate for radiative cooling according to an embodiment of the present disclosure; and

FIG. 2 is a reflectance graph of a laminate for radiative cooling according to an example of embodiments of the present disclosure and a laminate according to a comparative example.

### DETAILED DESCRIPTION OF ILLUSTRATIVE EMBODIMENTS

Herein, when a component “includes” another component, this means that the former component may further include other components without excluding other components unless otherwise stated.

Herein, when a member is described to be located on a “surface”, “top”, “one surface”, “the other surface”, or “both surfaces” of another member, this includes not only a case in which the former member is in contact with the latter member, but also a case in which a third member exists between the two members.

In addition, a “weight average molecular weight” used herein is measured by a conventional method known in the art, and may be measured, for example, by a gel permeation chromatograph (GPC) method.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

### Laminate for Color Radiative Cooling

A laminate for color radiative cooling according to embodiments of the present disclosure includes a colored layer, a visible ray reflective and far-infrared ray emissive layer formed on the colored layer, and a near-infrared ray reflective layer formed on the far-infrared ray emissive layer.

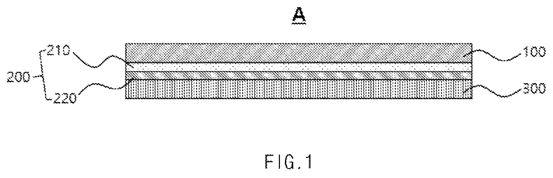

Referring to FIG. 1, a laminate ‘A’ for color radiative cooling according to embodiments of the present disclosure may have a form in which a colored layer 100, a far-infrared ray emissive layer 200, and a near-infrared ray reflective layer 300 are stacked in order, and the far-infrared ray emissive layer 200 may have a form in which a first layer 210 containing an aromatic polyester and a second layer 220 containing a non-aromatic poly (ether-ester) copolymer are alternately stacked.

### Colored Layer

The colored layer serves to impart a color to the laminate.

The colored layer contains a thermoplastic resin. Specifically, the colored layer may contain the thermoplastic resin and be colored in a chromatic color.

The thermoplastic resin may contain at least one selected from a group consisting of poly (methyl methacrylate) (PMMA), poly (vinyl alcohol) (PVA), polydimethylsiloxane (PDMS), polychlorotrifluoroethylene (PCTFE), polylactic acid (PLA), polymethylpentene (PMP), polyethylene (PE), cellulose, and a copolymer thereof. Specifically, the thermoplastic resin may contain the poly (methyl methacrylate).

In addition, the thermoplastic resin may have a weight average molecular weight (Mw) in a range from 20,000 to 100,000 g/mol, from 20,000 to 50,000 g/mol, or from 50,000 to 100,000 g/mol. When the weight average molecular weight of the thermoplastic resin is out of the above range, an infrared refractive index of the laminate may decrease or an infrared emissivity thereof may decrease, resulting in insufficient radiative cooling performance. The colored layer may be colored in the chromatic color.

In addition, the colored layer may have an average thickness in a range from 10 to 200 μm, from 10 to 150 μm, or from 50 to 100 μm. When the average thickness of the colored layer is smaller than the above range, a problem of insufficient infrared emissivity of the laminate may occur, and when the average thickness exceeds the above range, a problem that a surface temperature cooling performance deteriorates may occur resulting from a decrease in a visible transmittance and an occurrence of broadband radiation in an infrared ray area of the laminate.

The colored layer may have a transmittance equal to or higher than 90%, equal to or higher than 95%, or in a range from 50 to 90% with respect to light having a wavelength in a range from 400 to 780 nm. When the transmittance of the colored layer with respect to the light having the wavelength in the range from 400 to 780 nm is lower than the above range, problems such as a decrease in a durability resulted from transmission of an ultraviolet ray, the laminate rendering a color other than a target color, or the insufficient radiative cooling performance of the laminate may occur.

### First Adhesive Layer

The laminate for the color radiative cooling may further include a first adhesive layer between the colored layer and the far-infrared ray emissive layer. In this regard, the first adhesive layer may contain a heat curing adhesive, an ultraviolet curing adhesive, or a moisture curing adhesive.

The heat curing adhesive may be used without particular limitation as long as it is an adhesive that is generally cured by heating.

The ultraviolet curing adhesive may be used without particular limitation as long as it is an adhesive that is generally cured by the ultraviolet ray and may contain, for example, an acrylic monomer and an ultraviolet photoinitiator.

The acrylic monomer may be used without particular limitation as long as it is an acrylic monomer generally applicable to the ultraviolet curing adhesive and may include, for example, at least one selected from a group consisting of an alkyl (meth)acrylate monomer and an amide group-containing unsaturated (meth)acrylic monomer.

The alkyl (meth)acrylate monomer may, for example, include methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, isopentyl (meth)acrylate, 2-methylbutyl (meth)acrylate, n-hexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, n-decyl (meth)acrylate, isodecyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, isobornyl (meth)acrylate, lauryl (meth)acrylate, and heptadecanoyl (meth)acrylate, but may not be limited thereto.

The amide group-containing unsaturated (meth)acrylic monomer may include, for example, (meth)acrylamide; N-alkyl (meth)acrylamide such as N-methyl (meth)acrylamide, N-ethyl (meth)acrylamide, N-isopropyl (meth)acrylamide, N-tert-butyl (meth)acrylamide, N-tert-octyl (meth)acrylamide, or N-octyl (meth)acrylamide; or N-vinyl caprolactam, N-vinyl-2-pyrrolidone, (meth)acryloyl morpholine, and N,N-dialkyl acrylamide. In this regard, the N,N-dialkyl acrylamide may include, for example, N,N-dimethyl (meth)acrylamide, N,N-diethyl (meth)acrylamide, N,N-dipropyl (meth)acrylamide, and N,N-dibutyl (meth)acrylamide, but may not be limited thereto.

In this regard, “(meth)acrylate” refers to methacrylate and/or acrylate, and “(meth)acryl” refers to acryl and/or methacryl.

The ultraviolet photoinitiator may be used without particular limitation as long as it is a photoinitiator that is generally applicable to the ultraviolet curing adhesive and may be, for example, an acyl phosphine oxide-based compound. In this regard, the acyl phosphine oxide-based compound may include, for example, ethylphenyl phosphinate, (2,6-dimethoxybenzoyl)-2,4,4-pentyl phosphine oxide, 2,4,6-trimethylbenzoyldiphenyl phosphine oxide, bis (2,4,6-trimethylbenzoyl)-phenyl phosphine oxide, bis (2,6-dimethoxybenzoyl)-2,4,4-trimethyl-pentyl phosphine oxide, 2-methylbenzoyldiphenyl phosphine oxide, 2,4,6-trimethylbenzoylphenyl phosphinic acid methyl ester, bis (2,6-dimethoxybenzoyl) phenyl phosphine oxide, and ethyl-2,4,6-trimethylbenzoyl phenyl phosphinate.

The moisture curing adhesive may be used without particular limitation as long as it is an adhesive that is generally cured by the moisture in the air and may be, for example, a polyurethane-based or acrylic-based adhesive. In this regard, the polyurethane-based adhesive may contain a urethane-based prepolymer and polyisocyanate.

The urethane-based prepolymer may contain a hydroxyl group and react with the polyisocyanate to cure the adhesive. In addition, the urethane-based prepolymer may be used without particular limitation as long as it is generally applicable to a urethane-based adhesive and may have, for example, a weight average molecular weight in a range from 5,500 to 6,500 g/mol, from 5,850 to 6,000 g/mol or from 6,100 to 6,500 g/mol.

In addition, the polyisocyanate may be used without particular limitation as long as it is generally applicable to the urethane-based adhesive. For example, a content of unreacted isocyanate groups (NCO %) may be in a range from 0.01 to 0.1% by weight, from 0.01 to 0.05% by weight, or from 0.05 to 0.1% by weight.

The first adhesive layer may have an average thickness in a range from 0.01 to 1.0 μm, from 0.01 to 0.5 μm, or from 0.01 to 0.1 μm. When the average thickness of the first adhesive layer is smaller than the above range, a problem in that an adhesive force between the colored layer and the far-infrared ray emissive layer is reduced may occur, and when the average thickness exceeds the above range, a problem in that the visible transmittance of the laminate is reduced may occur.

### Far-Infrared Ray Emissive Layer

The far-infrared ray emissive layer may emit a far-infrared ray having a wavelength in a range from 8,000 to 13,000 nm and reflect a visible ray to emit heat from the laminate.

The far-infrared ray emissive layer includes a form in which the aromatic polyester-containing first layer and the non-aromatic poly (ether-ester) copolymer-containing second layer are alternately stacked. When the form in which the aromatic polyester-containing first layer and the non-aromatic poly (ether-ester) copolymer-containing second layer are alternately stacked is included as the far-infrared ray emissive layer, the aromatic polyester-containing first layer with a relatively high refractive index and the non-aromatic poly (ether-ester) copolymer-containing second layer with a relatively low refractive index are alternately stacked to cause an interference therebetween to change a travel direction of light, thereby effectively blocking the heat.

Specifically, in the far-infrared ray emissive layer, the total number of layers of the first layer and the second layer may be in a range from 300 to 600 layers, from 300 to 400 layers, or from 400 to 600 layers. When the total number of layers of the first layer and the second layer is smaller than the above range, a problem in which a visible reflectance decreases may occur, and when the total number exceeds the above range, a problem that a reflectance increases at a wavelength other than the visible ray (for example, a wavelength in a range from 400 to 790 nm) and thus a problem that the laminate has the color other than the target color may occur.

The aromatic polyester may include at least one selected from a group consisting of polyethyleneterephthalate (PET), polypropyleneterephthalate (PPT), polybutyleneterephthalate (PBT), and polyethylene naphthalate (PEN). Specifically, the aromatic polyester may be the polyethyleneterephthalate.

In addition, the aromatic polyester may have a weight average molecular weight in a range from 50,000 to 300,000 g/mol or from 100,000 to 250,000 g/mol. When the weight average molecular weight of the aromatic polyester is out of the above range, a far-infrared emissivity and the visible reflectance may decrease, and thus, the radiative cooling performance of the laminate may deteriorate.

Specifically, the first layer may be an aromatic polyester film. More specifically, the first layer may be a PET film.

The first layer may have an average thickness in a range from 0.05 to 0.20 μm, from 0.06 to 0.18 μm, or from 0.08 to 0.17 μm. When the average thickness of the first layer is smaller than the above range, the problem in which the visible reflectance and the far-infrared emissivity decrease may occur, and when the average thickness exceeds the above range, a problem in which a reflection effect for an unwanted wavelength increases, resulting in the laminate rendering the color other than the target color or the insufficient radiative cooling performance of the laminate occurring.

In addition, the first layer may have the refractive index equal to or higher than 1.5, equal to or higher than 1.6, or in a range from 1.6 to 1.8.

The non-aromatic poly (ether-ester) copolymer may contain a cycloalkane dicarboxylic acid-based repeating unit, a cycloalkanediol-based repeating unit, and an alkylene ether glycol-based repeating unit.

The cycloalkane dicarboxylic acid-based repeating unit may be derived from cyclohexanedicarboxylic acid or an ester thereof.

The cycloalkanediol-based repeating unit may be derived from at least one selected from a group consisting of cyclohexane dimethanol, cyclopentane dimethanol, and cycloheptane dimethanol.

The alkylene ether glycol-based repeating unit may be derived from at least one selected from a group consisting of trimethylene ether glycol, tetramethylene ether glycol, pentamethylene ether glycol, and a precursor diol compound thereof.

The non-aromatic poly (ether-ester) copolymer may have a weight average molecular weight in a range from 80,000 to 200,000 g/mol or from 140,000 to 180,000 g/mol. When the weight average molecular weight of the non-aromatic poly (ether-ester) copolymer is out of the above range, the far-infrared emissivity and the visible reflectance may decrease, and thus, the radiative cooling performance of the laminate may deteriorate.

In addition, the second layer may have an average thickness in a range from 0.05 to 0.20 μm, from 0.06 to 0.18 μm, or from 0.08 to 0.17 μm. When the average thickness of the second layer is smaller than the above range, the problem in which the visible reflectance decreases may occur, and when the average thickness exceeds the above range, the problem in which the reflection effect for the unwanted wavelength increases, resulting in the laminate rendering the color other than the target color or the insufficient radiative cooling performance of the laminate occurring.

The second layer may have the refractive index lower than 1.5, equal to or higher than 1.3 and lower than 1.5, or equal to or higher than 1.4 and lower than 1.5.

The far-infrared ray emissive layer may have an average thickness in a range from 10 to 200 μm, from 20 to 150 μm, or from 50 to 100 μm. When the average thickness of the far-infrared ray emissive layer is smaller than the above range, the problem in which the visible reflectance and the far-infrared emissivity decreases may occur, and when the average thickness exceeds the above range, the problem in which the reflection effect for the unwanted wavelength increases, resulting in the laminate rendering the color other than the target color or the insufficient radiative cooling performance of the laminate occurring.

### Near-Infrared Ray Reflective Layer

The near-infrared ray reflective layer may block the heat by reflecting a near-infrared ray having a wavelength in a range from 700 to 2,500 nm.

The near-infrared ray reflective layer contains metal. For example, the near-infrared ray reflective layer may contain at least one metal selected from a group consisting of silver (Ag), gold (Au), chromium (Cr), copper (Cu), platinum (Pt), iron (Fe), tin (Sn), and nickel (Ni). Specifically, the near-infrared ray reflective layer may contain Ag, Au, or Cr.

In addition, the near-infrared ray reflective layer may have an average thickness in a range from 0.01 to 0.50 μm, from 0.06 to 0.20 μm, or from 0.07 to 0.15 μm. When the average thickness of the near-infrared ray reflective layer is smaller than the above range, a problem that a near-infrared ray reflection effect is reduced, resulting in the insufficient radiative cooling performance of the laminate, may occur, and when the average thickness exceeds the above range, the problem in which the reflection effect for light of the unwanted wavelength increases, resulting in the laminate rendering the color other than the target color, may occur.

### Second Adhesive Layer

The laminate for the color radiative cooling may further include a second adhesive layer between the far-infrared ray emissive layer and the near-infrared ray reflective layer. In this regard, the second adhesive layer may contain the ultraviolet curing adhesive or the heat curing adhesive.

Each of the ultraviolet curing adhesive and the heat curing adhesive is as described in the first adhesive layer.

In addition, the second adhesive layer may have an average thickness in a range from 0.01 to 1.0 μm, from 0.01 to 0.5 μm, or from 0.01 to 0.1 μm. When the average thickness of the second adhesive layer is smaller than the above range, a problem in that an adhesive force between the far-infrared ray emissive layer and the near-infrared ray reflective layer is reduced may occur, and when the average thickness exceeds the above range, a problem in that visible and near-infrared reflectance is reduced may occur.

The laminate for the color radiative cooling may have an emissivity equal to or higher than 80%, equal to or higher than 85%, or equal to or higher than 90% with respect to a wavelength in a range from 8 to 14 μm. In addition, the laminate for the color radiative cooling may have a reflectance equal to or higher than 80%, equal to or higher than 85%, equal to or higher than 90%, or equal to or higher than 95% with respect to a near-infrared ray having a wavelength in a range from 0.3 to 2 μm.

The laminate for the color radiative cooling according to embodiments of the present disclosure as described above has excellent visible and infrared reflectivity and the excellent infrared emissivity and thus has very excellent radiative cooling performance. In addition, the laminate for the radiative cooling has excellent emissivity for the wavelength in a range from 8 to 14 μm, which is an atmospheric window, and thus has the excellent radiative cooling performance. Furthermore, the laminate for the radiative cooling may have the very excellent radiative cooling performance because of low absorption of heat energy by convection and thus may be suitably used as a material in various fields requiring a material with the excellent radiative cooling performance, such as a vehicle.

### Radiative Cooling Material

A radiative cooling material of embodiments of the present disclosure includes the laminate for the color radiative cooling.

As described above, the radiative cooling material includes the laminate for the radiative cooling having the excellent far-infrared emissivity and near-infrared reflectivity and thus having the very excellent radiative cooling performance, so that the radiative cooling material may be suitably used as the material in the various fields requiring the material with the excellent radiative cooling performance, such as the vehicle.

### Vehicle or Building

A vehicle or a building of embodiments of the present disclosure contains the radiative cooling material. As a result, the vehicle and the building are able to save cooling energy in summer and thus have excellent energy efficiency.

Hereinafter, embodiments of the present disclosure will be described in more detail via examples. However, such examples are only for helping understanding of embodiments of the present disclosure, and the scope of the present disclosure is not limited to such examples in any sense.

### EXAMPLES

### Example 1. Preparation of Laminate

The PET (manufacturer: SM chemical, product name: Tex Pet, and refractive index: 1.66) as the first layer and the non-aromatic poly (ether-ester) copolymer (Manufacturer: 3M, product name: Vikuiti, and refractive index: 1.49) composed of a first repeating unit derived from the cyclohexanedicarboxylic acid, a second repeating unit derived from the cyclohexane dimethanol, and a third repeating unit derived from the tetramethylene ether glycol as the second layer were alternately extruded by 600 layers such that a thickness of each layer is 0.125 μm by co-extrusion to prepare the far-infrared ray emissive layer with the average thickness of 75 μm.

The heat curing adhesive (manufacturer: 3M, product name: 96105CR) was applied onto the colored layer composed of the PMMA (manufacturer: LX MMA, product name: AR 700, and average thickness: 50 μm) to form the first adhesive layer with the average thickness of 0.05 μm.

Thereafter, after stacking the far-infrared ray emissive layer on the first adhesive layer, the heat curing adhesive (manufacturer: 3M, product name: 96105CR) was applied onto the far-infrared ray emissive layer to form the second adhesive layer with the average thickness of 0.05 μm.

Thereafter, silver (Ag) was deposited onto the second adhesive layer by a sputter deposition method to stack the near-infrared ray reflective layer with the average thickness of 0.1 μm to prepare the laminate.

### Comparative Example 1

A laminate was prepared in the same manner as that in Example 1, except that the stacking order was changed to an order of the colored layer, the near-infrared ray reflective layer, and the far-infrared ray emissive layer.

### Examples 2 to 5 and Comparative Examples 1 to 3

Laminates were prepared in the same manner as that in Example 1, except that a thickness and a composition of each layer were adjusted as shown in Table 1.

TABLE 1

| | | | | | | Near- |
|---|---|---|---|---|---|---|
| | | Far-infrared ray emissive layer | | | | infrared ray |
| | Colored | First | Second | | | reflective |
| | layer | layer | layer | | | layer |
| | thickness | thickness | thickness | Number | Total | thickness |
| | (μm) | (μm) | (μm) | of layers | thickness | (μm) |
| Example 1 | 50 | 0.125 | 0.125 | 600 | 75 | 0.1 |
| Example 2 | 50 | 0.083 | 0.083 | 600 | 50 | 0.1 |
| Example 3 | 50 | 0.167 | 0.167 | 600 | 100 | 0.1 |
| Example 4 | 50 | 0.125 | 0.125 | 600 | 75 | 0.05 |
| Example 5 | 50 | 0.125 | 0.125 | 600 | 75 | 0.3 |
| Comparative | 50 | — | — | — | — | 0.1 |
| Example 2 | | | | | | |
| Comparative | 50 | 0.125 | 0.125 | 600 | 75 | — |
| Example 3 | | | | | | |

### Test Example: Evaluation of Characteristics

Physical properties of the laminates of the Examples and the Comparative Examples were evaluated in the following manner, and the results are shown in Table 2.

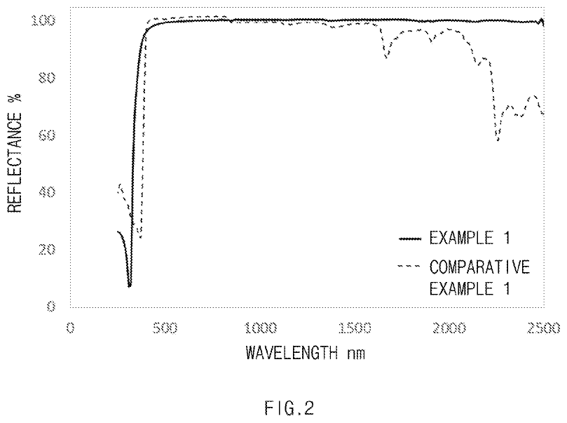

After mounting an integrating sphere on an ultraviolet-visible spectrophotometer (UV-VIS spectrophotometer) and a Fourier transform infrared spectrometer (FT-IR), reflectance for a wavelength in a range from 0.2 to 20 μm of the laminates of the Examples and the Comparative Examples were measured and then the average emissivity thereof was calculated. In addition, the reflectance measurement results of the laminates of Example 1 and Comparative Example 1 are shown in FIG. 2.

TABLE 2

| | Average emissivity (%) | Average reflectance (%) |
|---|---|---|
| | for wavelength in range | for wavelength in range |
| | from 8 to 14 μm | from 0.3 to 2 μm |
| Example 1 | 90 | 97 |
| Example 2 | 90 | 50 |
| Example 3 | 90 | 97 |
| Example 4 | 90 | 70 |
| Example 5 | 90 | 97 |
| Comparative | 90 | 94 |
| Example 1 | | |
| Comparative | 10 | 50 |
| Example 2 | | |
| Comparative | 90 | 50 |
| Example 3 | | |

As shown in Table 2, the laminate of Example 1 has a remarkably high emissivity of 90% for the wavelength in the range from 8 to 14 μm, which is the atmospheric window, and has a high reflectance of 97% for the near-infrared ray of the wavelength in the range from 0.3 to 2 μm, and thus, is determined to have the excellent radiative cooling performance.

On the other hand, as shown in Table 2 and FIG. 2, the laminate of Comparative Example 1 in which the colored layer, the near-infrared ray reflective layer, and the far-infrared ray emissive layer are stacked in order lacks the reflectance for the wavelength in the range from 0.3 to 2 μm. In particular, it was found that the laminate of Comparative Example 1 has a significantly low reflectance for a wavelength equal to or higher than 1800 nm.

The laminate for the color radiative cooling according to embodiments of the present disclosure has the excellent ultraviolet, visible, and near-infrared reflectivity and the excellent far-infrared emissivity, and thus, has the very excellent radiative cooling performance. In addition, the laminate for the radiative cooling has the excellent emissivity for the wavelength in the range from 8 to 14 μm, which is the atmospheric window, and thus has the excellent radiative cooling performance. Furthermore, the laminate for the radiative cooling has the very excellent radiative cooling performance, so that the laminate may be suitably used as the material in the various fields such as the vehicle, an aircraft (e.g., an advanced air mobility (AAM) and an urban air mobility (UAM)), a robot, a building, and the like that require the material having the excellent radiative cooling performance.

Hereinabove, although embodiments of the present disclosure have been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A laminate for color radiative cooling, the laminate comprising:
a colored layer comprising a thermoplastic resin;
a far-infrared ray emissive layer on the colored layer, wherein a first layer comprising an aromatic polyester and a second layer comprising a non-aromatic poly (ether-ester) copolymer are alternately stacked in the far-infrared ray emissive layer; and
a near-infrared ray reflective layer on the far-infrared ray emissive layer and comprising a metal.

2. The laminate of claim 1, wherein the thermoplastic resin comprises at least one material selected from a group consisting of poly (methyl methacrylate) (PMMA), poly (vinyl alcohol) (PVA), polydimethylsiloxane (PDMS), polychlorotrifluoroethylene (PCTFE), polylactic acid (PLA), polymethylpentene (PMP), polyethylene (PE), cellulose, and a copolymer of those.

3. The laminate of claim 1, wherein the colored layer is colored in a chromatic color.

4. The laminate of claim 1, wherein the colored layer has a transmittance equal to or higher than 90% for light with a wavelength in a range from 400 to 780 nm.

5. The laminate of claim 1, wherein the non-aromatic poly (ether-ester) copolymer comprises a cycloalkane dicarboxylic acid-based repeating unit, a cycloalkanediol-based repeating unit, and an alkylene ether glycol-based repeating unit.

6. The laminate of claim 5, wherein the cycloalkane dicarboxylic acid-based repeating unit is derived from cyclohexanedicarboxylic acid or an ester of the cyclohexanedicarboxylic acid.

7. The laminate of claim 5, wherein the cycloalkanediol-based repeating unit is derived from at least one material selected from a group consisting of cyclohexane dimethanol, cyclopentane dimethanol, and cycloheptane dimethanol.

8. The laminate of claim 5, wherein the alkylene ether glycol-based repeating unit is derived from at least one material selected from a group consisting of trimethylene ether glycol, tetramethylene ether glycol, pentamethylene ether glycol, and a precursor diol compound of those.

9. The laminate of claim 1, wherein the aromatic polyester comprises at least one material selected from a group consisting of polyethyleneterephthalate (PET), polypropyleneterephthalate (PPT), polybutyleneterephthalate (PBT), and polyethylene naphthalate (PEN).

10. The laminate of claim 1, wherein the far-infrared ray emissive layer has a total number of layers of the first layer and the second layer in a range from 300 to 600 layers.

11. The laminate of claim 1, wherein:
the first layer has an average thickness in a range from 0.05 to 0.20 μm; and
the second layer has an average thickness in a range from 0.05 to 0.20 μm.

12. The laminate of claim 1, wherein the metal in the near-infrared ray reflective layer comprises at least one metal selected from a group consisting of silver (Ag), gold (Au), chromium (Cr), copper (Cu), platinum (Pt), iron (Fe), tin (Sn), and nickel (Ni).

13. The laminate of claim 1, wherein:
the far-infrared ray emissive layer is configured to emit a far-infrared ray with a wavelength in a range from 8,000 to 13,000 nm; and
the near-infrared ray reflective layer is configured to reflect a near-infrared ray with a wavelength in a range from 700 to 2,500 nm.

14. The laminate of claim 1, wherein:
the colored layer has an average thickness in a range from 10 to 200 μm;
the far-infrared ray emissive layer has an average thickness in a range from 10 to 200 μm; and
the near-infrared ray reflective layer has an average thickness in a range from 0.01 to 0.50 μm.

15. A radiative cooling material comprising:
a laminate comprising:
a colored layer comprising a thermoplastic resin;
a far-infrared ray emissive layer on the colored layer, wherein a plurality of first layers each comprising an aromatic polyester and a plurality of second layers each comprising a non-aromatic poly (ether-ester) copolymer are alternately stacked in the far-infrared ray emissive layer; and
a near-infrared ray reflective layer on the far-infrared ray emissive layer and comprising a metal.

16. The radiative cooling material of claim 15, wherein the thermoplastic resin comprises at least one material selected from a group consisting of poly (methyl methacrylate) (PMMA), poly (vinyl alcohol) (PVA), polydimethylsiloxane (PDMS), polychlorotrifluoroethylene (PCTFE), polylactic acid (PLA), polymethylpentene (PMP), polyethylene (PE), cellulose, and a copolymer of those.

17. The radiative cooling material of claim 15, wherein the colored layer is colored in a chromatic color and has a transmittance equal to or higher than 90% for light with a wavelength in a range from 400 to 780 nm.

18. The radiative cooling material of claim 15, wherein:
the non-aromatic poly (ether-ester) copolymer comprises a cycloalkane dicarboxylic acid-based repeating unit, a cycloalkanediol-based repeating unit, and an alkylene ether glycol-based repeating unit;
the cycloalkane dicarboxylic acid-based repeating unit is derived from cyclohexanedicarboxylic acid or an ester of the cyclohexanedicarboxylic acid;
the cycloalkanediol-based repeating unit is derived from at least one material selected from a group consisting of cyclohexane dimethanol, cyclopentane dimethanol, and cycloheptane dimethanol; and
the alkylene ether glycol-based repeating unit is derived from at least one material selected from a group consisting of trimethylene ether glycol, tetramethylene ether glycol, pentamethylene ether glycol, and a precursor diol compound of those.

19. The radiative cooling material of claim 15, wherein the aromatic polyester comprises at least one material selected from a group consisting of polyethyleneterephthalate (PET), polypropyleneterephthalate (PPT), polybutyleneterephthalate (PBT), and polyethylene naphthalate (PEN).

20. The radiative cooling material of claim 15, wherein:
the colored layer has an average thickness in a range from 10 to 200 μm;
the far-infrared ray emissive layer has an average thickness in a range from 10 to 200 μm; and
the near-infrared ray reflective layer has an average thickness in a range from 0.01 to 0.50 μm.
